(19) United States
(12) Patent Application Publication
(10) Pub. No.: US 2005/0227204 A1
(43) Pub. Date: Oct. 13, 2005

(54) Daily wear temporary dental veneers

(76) Inventor: Douglas J. Hauck, Beverly Hills, CA (US)

Correspondence Address: BIRCH STEWART KOLASCH & BIRCH, PO BOX 747, FALLS CHURCH, VA, 22040-0747, US

(21) Appl. No.: 11/075,512

(22) Filed: Mar. 8, 2005

Related U.S. Application Data
(60) Provisional application No. 60/561,751, filed on Apr. 12, 2004.

(51) Int. Cl. A61C 5/08

(52) U.S. Cl. 433/218

(57) ABSTRACT

A method for temporarily improving an individual's smile, without any alteration of the individual's teeth comprising, providing the individual with a plurality of thin, cosmetically pleasing, reusable veneers, each veneer designed to cover one tooth, and also providing the individual with a non-toxic bonding agent, so that the individual can personally attach a veneer to the front of a number of the individual's teeth by applying a thin layer of the bonding agent to a tooth or to the veneer, and pressing the veneer onto the tooth.

This invention is described in my Provisional Patent Application filed on Apr. 12, 2004, bearing application number 60/561,751.

### BACKGROUND OF THE INVENTION

Many people have discolored, dark or stained teeth, chipped or broken teeth, short teeth, and/or spaces between their teeth, or misaligned or maloccluded teeth. Many, with these problems, are reluctant to smile because of the unattractive appearance of their teeth. In order to achieve an attractive, flawless smile, these people now have to spend tens of thousands of dollars for permanent cosmetic dentistry to correct their appearance, even though these teeth are sometimes quite healthy.

A number of different procedures are currently available to improve a person's appearance and smile. These include caps, crowns, bonding and permanent veneers. All of these procedures require preparation and preshaping of a tooth, including cutting, drilling, grinding, etching, scraping and other procedures, which are usually accompanied by “pain” or discomfort to the patient, requiring “pain” killing shots to be used prior to the procedure. These procedures often cause permanent, irreversible alterations of healthy, normal teeth. These procedures usually require multiple trips to the dentist and great expense to the patient, often from $1,000 to $3,000, or more, per tooth.

Another form of permanent veneer is manufactured by Da Vinci Studios, which they call Da Vinci Veneers™. However, these veneers are designed to stay attached for many years, require irreversible tooth preparation and are quite expensive, running anywhere from $5,000 to $75,000, a set.

Chemical bonding compounds are used for these permanent veneers, which are designed to bond the veneers to the teeth for life. If, for any reason the patient wants to, or needs to, remove the permanent veneers, drilling is required, which generates great heat, which can cause damage to the teeth, which have already been irreversibly altered at the time of attachment.

### BRIEF SUGARY OF THE INVENTION

Applicant's invention comprises the use of temporary veneers for cosmetic purposes only, to provide a beautiful, flawless smile for special occasions when desired by the user, or for everyday life, without visits to the dentist, shots or irreversible alteration of the teeth.

The temporary veneers are usually applied to the anterior upper teeth only, although the lower teeth, as well as additional teeth can also be provided with temporary veneers. Application and removal of the temporary veneers provides the freedom and economy of choice and permits the user to choose various veneers of differing, styles, shapes, colors, etc. People who have always wanted a great smile but dislike the trip to the dentist can now, if only for a day, or a few days, have the smile they always wanted.

### OBJECTS OF THE INVENTION

Accordingly, several objects and advantages of the invention are as follows:

It is an object of the present invention to provide a simple method of covering an unattractive smile and having instead, a beautiful smile, a day at a time.

Another object of the invention is to provide an inexpensive way to have a beautiful smile without trips to the dentist.

Still another object of the invention is to provide temporary veneers for the teeth, which require no tooth preparation and are easily removed and replaced at will.

These, as well as other objects of the invention, will become obvious from the following description in which:

### BRIEF DESCRIPTION OF THE DRAWINGS

FIG. 1 is a front view of the anterior upper teeth, without temporary veneers;

FIG. 2 is a front view of the anterior upper teeth, with temporary veneers;

FIG. 3 is an exploded cross-section view of one tooth and veneer; and

FIG. 4 is a cross-section view of the tooth of FIG. 3 with the veneer attached.

### DETAILED DESCRIPTION OF THE INVENTION

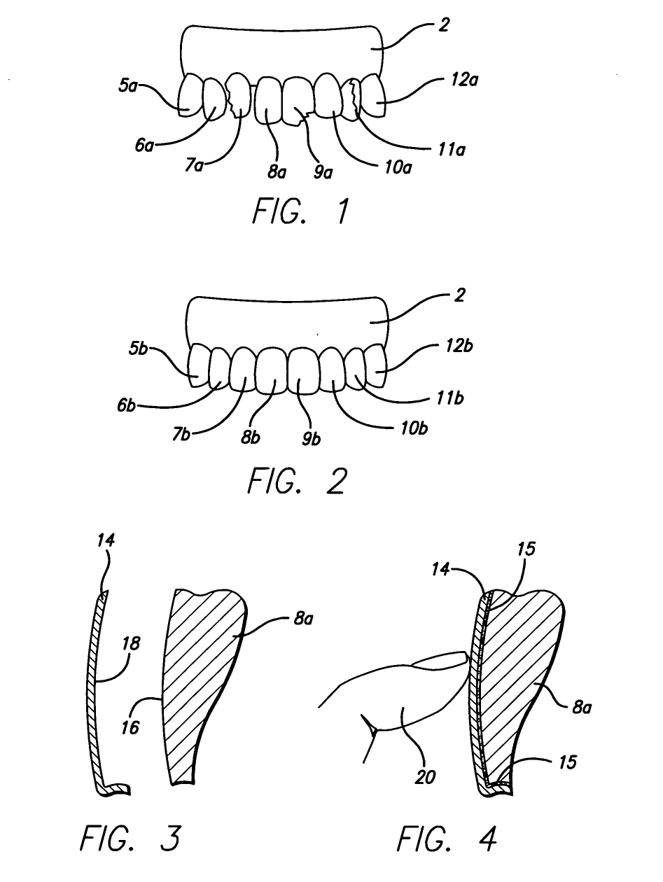

Referring now to the drawings, there is shown in FIGS. 1 and 2, the gum line 2 of a patient and the eight anterior upper teeth 5a through 12a, which include the four incisors, the two canines, and two bicuspids. As can be seen in FIG. 1, the teeth are misaligned. Tooth 7a and tooth 9a are broken off in part and tooth 11a is cracked. There is a space between teeth 6a and 7a and between 7a and 8a. Tooth 11a sits partially behind tooth 10a.

In FIG. 2, the temporary veneers 5b to 12b of this invention have been removably attached to all of the teeth shown, and a beautiful, even smile is the result. While only the eight anterior maxilla teeth are shown, the mandibular teeth can also have veneers applied, as well as the molars, if desired. Primarily however, the temporary veneers of this invention are for cosmetic and vanity purposes only, to create a beautiful smile, and often only the front, anterior upper teeth need to have the temporary veneers applied, to achieve the desired result.

FIG. 3 shows one tooth 8a with a temporary veneer 14 ready to be affixed thereto. FIG. 4 shows tooth 8a with veneer 14 attached. A moderate, non-toxic cement or-bonding agent 15 is applied to the outside surface 16 of tooth 8a, or to the inside surface 18 of veneer 14, preferably using a small brush or a finger. The patient then uses his or her finger 20 to press veneer 14 onto tooth 8a. The patient continues the pressure on the veneer for a few seconds, about 2 to 5 seconds, to allow the cement or bonding agent to take hold. The cement or bonding agent will dry completely in a few minutes and the patient can eat and drink normally thereafter. The cement or bonding agent used is strong enough to mate the daily temporary veneers to the natural teeth without any tooth preparation, drilling, etching or any other preparation.

Cements that may be used to affix the temporary veneers are a moderately bonding, non-toxic adhesive or dental adhesives commonly used by dentists, including polymer adhesives such as Stomahevise® Paste, manufactured by ConvaTec of Princeton, N.J.

The veneers can be removed by the use of a warm water rinse in the mouth, after which the temporary veneers can be pulled off. The patient can then clean any remaining bonding agent off of the teeth by flossing and brushing. The veneers should preferably not be worn exceeding a 24 hour period. The temporary veneers should not be left on when going to sleep at night.

The temporary veneers of this invention can be custom made by a dentist or can be pre-formed anterior veneers of various sizes, shapes and shades. A cement or glue required to attach the veneers to the natural anterior teeth is provided to the user. The user will apply a thin layer of the cement and press a single veneer, for a single tooth, onto the appropriate natural tooth. The user repeats this procedure for each anterior tooth, or so many as the user chooses. The user continues to exercise good oral hygiene, including brushing and flossing.

The temporary veneers can be made of porcelain, plastic, other semi-rigid composite materials, or combinations thereof. The temporary veneers can be easily removed and cleaned so that they are capable of being used for everyday wear, yet can be removed as required or desired. Then after cleaning and daily hygienic activities, such as brushing and flossing, they can be reapplied. The veneers can be from about 0.2 mm to about 1 mm in thickness and be available in sizes that conform to a majority of anterior teeth structures.

If desired, a custom set of press-on veneers can be made in a simple, non-invasive trip to a dentist. The dentist takes a mold of the patient's teeth, and the lab makes custom sized and shaped temporary veneers for the patient. The veneers then conform to any unusual tooth formations.

Alternatively, the mold device can be sent to the patient at their home and the patient can take their own impression, biting into the mold and mailing it back to the dentist or directly to a laboratory. Then a set of custom veneers can be mailed back to the patient at their home.

Another method is to pre-manufacture sets of temporary veneers in a large variety of shapes and sizes, which are then packaged together as a kit, with a container of a bonding agent, for retail purchase, so that the individual can purchase the package and pick and choose the size, shape and fit needed, to their own personal desire. This method allows the user to choose a particular shape or style of veneers, which the user can vary, according to their fashion desire at the moment.

The temporary veneers of this invention are particularly useful for special occasions when pictures are being taken, such as a wedding, reunion, business meeting or special event dinner, where the user wants to have a beautiful smile showing in the pictures taken.

Having thus described the invention,

1: A method for temporarily improving an individual's smile, without any alteration of the individual's teeth comprising, providing the individual with a plurality of thin, cosmetically pleasing, reusable veneers, each veneer designed to cover one tooth, and also providing the individual with a non-toxic bonding agent, so that the individual can personally attach a veneer to the front of a number of the individual's teeth by applying a thin layer of the bonding agent to a tooth or to the veneer, and pressing the veneer onto the tooth.

2: The method of claim 1 or 10 in which the veneers are applied only to the anterior upper incisors and canine teeth.

3: The method of claim 1 or 10 in which the veneers are custom made to conform to the individual's teeth.

4: The method of claim 3 or 10 in which the veneers are custom made by taking a mold of the individual's teeth and making the veneers from the mold.

5: The method of claim 1 or 10 in which the veneers are made of porcelain or plastic.

6: The method of claim 1 or 10 in which the bonding agent is a polymer.

7: The method of claim 1 or 10 in which the veneers are pre-made in a plurality of shapes and sizes and provided to the individual for the individual's choice of use.

8: The method of claim 1 or 10 in which the veneers are removed by pulling them off of the teeth.

9: The method of claim 1 or 10 in which the veneers are removed by rinsing with warm water and then pulling them off of the teeth.

10: A method for temporarily improving an individual's smile on a daily basis, without any alteration of the individual's teeth comprising, providing the individual with a plurality of thin, cosmetically pleasing, reusable veneers, each veneer designed to cover one tooth, and also providing the individual with a non-toxic bonding agent, so that the individual can personally attach a veneer to the front of a number of the individuals teeth by applying a thin layer of the bonding agent to a tooth or to the veneer, and pressing the veneer onto the tooth, removing the veneers at the end of each day and reapplying them the next day.

11: The method of claim 1 or 10 in which the teeth are cleaned by flossing and brushing after removal of the temporary veneers.

12: The method of claim 1 or 10 in which the veneers are cleaned after removal by brushing.

13: A kit comprising, a set of cosmetically pleasing, temporary, reusable veneers for an individual's teeth, one veneer for each tooth, and a container of a non-toxic bonding agent.

14: The kit of claim 13 comprising veneers which are custom made to conform to the individual's teeth.

15: The kit of claim 13 in which the veneers are pre-made in a plurality of shapes and sizes.

16: The kit of claim 13 in which the veneers are made of porcelain or plastic.

17: The kit of claim 16 in which the veneers are from about 0.2 mm to about 1 mm thick.

18: The kit of claim 13 in which the kit contains individual veneers for only the anterior, upper incisors, canine and bicuspid teeth.

19: A method for temporarily improving an individual's smile on a daily basis, without any alteration of the individual's teeth comprising, making a dental mold of the individual's teeth, manufacturing from the mold a custom set of thin, cosmetically pleasing, reusable veneers, each veneer custom designed to cover one tooth, providing the individual with a non-toxic bonding agent, so that the individual can personally attach a veneer to the front of a number of the individual's own teeth by applying a thin layer of the bonding agent to a tooth or to the veneer, and pressing the veneer onto the tooth, and removing the veneers at the end of each day.

20: The process of claim 19 in which the mold of the individual's teeth is taken in a dentist's office.

21: The process of claim 20 in which the veneers are made in a dental laboratory.

22: The process of claim 19 in which the mold is mailed to the individual, the individual makes a mold of the individual's own teeth and mails the mold back to a dentist or a dental laboratory for manufacture of the veneers.
